(19) United States
(12) Patent Application Publication
(10) Pub. No.: US 2012/0126170 A1
(43) Pub. Date: May 24, 2012

(54) Chewing Tobacco (dip) Moisturizing Solution

(76) Inventor: Kirk Norman, Lake Worth, FL (US)

(21) Appl. No.: 12/951,009

(22) Filed: Nov. 20, 2010

(51) Int. Cl. C09K 3/00

(52) U.S. Cl. 252/194

(57) ABSTRACT

The present invention provides a water-base or an oil-in-water emulsified product containing optional flavoring additives as desired, which has the effect of moisturizing chewing tobacco (dip), and causing improved flavor as well as a more enjoyable chewing experience. The invention provides a liquid solution that is convenient, at hand, and ready-to-use.

### CROSS REFERENCE TO RELATED APPLICATIONS

The following are patents to site as related items: For the Chewing Tobacco (dip) moisturizing solution.

U.S. Pat. No. 5,251,648 October 1993 Ogawa, et al.
U.S. Pat. No. 6,079,418 June 2000 Russo
U.S. Pat. No. 6,082,370 July 2000 Russo
U.S. Pat. No. 7,531,196 May 2009 Kopas, et al.
U.S. Pat. No. 6,962,711 November 2005 Schneider, et al.
U.S. Pat. No. 6,348,479 February 2002 Mori, et al.
U.S. Pat. No. 5,008,037 April 1991 Weete, et al.
U.S. Pat. No. 6,849,282 5 February Gao, et al.
U.S. Pat. No. 7,597,923 9 October Kobayashi, et al.
U.S. Pat. No. 4,086,927 May 1978 Pittet, et al.

### BACKGROUND OF THE INVENTION

Chewing tobacco is available in many forms. A very popular form of chewing tobacco that is available to consumers is packaged in small circular plastic cans, approximately 8.25 inches in circumference, sometimes referred to as “tins” since they were originally packaged in tin cans. These cans typically hold 1 to 1.5 oz of finely cut tobacco and come in various flavors such as “straight”, “wintergreen” and “Cherry”. To use—a pinch of this tobacco is placed between the gum and lip. Consumers prefer moist tobacco. Sometimes a new can, previously unopened, will not have the desired moisture. Sometimes a can will be opened and lose its freshness by drying out.

To correct this problem of dryness in a can of tobacco, consumers sometimes attempt to add moisture. This has been done in many different ways: including adding a splash of drinking alcohol, placing slices of apples in the can, dripping tap water through the fingers to add the correct amount. An additional problem arises if too much moisture is added. This will make the texture and flavor of the tobacco less desirable. Using these methods prove difficult to add the proper amount of moisture and risk changing the flavor or texture in an undesirable way.

Another issue with the various homemade remedies is that the moisture will sometimes over saturate small pockets of the tobacco and under saturate other pockets when it is not dispersed evenly.

Many chewing tobacco users are not aware of the homemade remedies for dry tobacco and will throw away stale chew and go purchase a fresh can instead of trying to remoisturize. Even those who know their tobacco can be re-moisturized will often not bother due to the inconvenience, difficulty and inconsistent results.

Those that do attempt to revitalize their tobacco must contend with the difficulty of calibrating and dispensing the correct amount of moisturizing solution as well as the flavor changing affects of the moisturizing agent they decide to use.

Currently, there is no product on the market that is specifically designed to moisturize chewing tobacco. There are many processes and patents pertaining to moisture in smoking tobacco, but none of these processes or methods work with chewing tobacco after it has been packaged or for the specific use of moisturizing smokeless tobacco (dip). There are also water and water-in-oil emulsified solutions used for food additives, flavorings and other additives.

This invention provides a means of effectively moisturizing chewing tobacco using a solution of water and oil with added flavorings that can be dispersed into cans of dip with a spray applicator or other means.

This present invention provides consumers with a convenience factor previously not available to them. The result is intended to eliminate the need to throw away stale cans of chew instead chewing tobacco users can revitalize the chew they already purchased.

The invention is also intended to enhance the tobacco chewing experience by bringing the moisture and flavor to an optimum level. The invention is also intended to add flavor to chewing tobacco by using a flavored solution.

The invention is a water solution with a small percentage of oil. An emulsifier assists in keeping the oil and water blended together. A variety of flavorings can be added to enhance the flavor of the dip, or the solution can be prepared without flavoring to keep the chewing tobacco flavor unchanged—so it only moistens the tobacco.

### BRIEF SUMMARY OF THE INVENTION

The Chewing Tobacco (dip) moisturizing solution is uses water as the main ingredient for the moisturizing effect and uses an emulsifier with a small amount of oil moisturizers in the solution. The oil ingredient can be one of many food grade oils, for example; coconut oil, vegetable oil or other food grade oils. Flavor can be added to enhance or change the flavor of the chewing tobacco to which it is added. The result, once the solution is applied, is chewing tobacco that tastes more moist and flavorful.

The solution is most effectively applied using a spray tip that disperses the solution evenly over the chewing tobacco. It can also be applied by other means such as dripping it into the can of dip. This method does not spread and penetrate as effectively as a spray application, although it is another viable method.

This invention is a convenient, ready-to-use, formulated solution to moisturize cans of dip. The invention offers a unique alternative to prolong the shelf life of dip and revitalize flavor and texture. This invention also provides a standardized, practical and effective way to moisturize dip as an alternative to the multiple homemade remedies that prove to be inconvenient to the point of not bothering to moisturize stale dip. The invention will also eliminate the inconsistent results of preparing homemade solutions.

### DETAILED DESCRIPTION OF THE INVENTION

This Chewing Tobacco (dip) moisturizing solution is primarily water. A small proportion of food grade oil is mixed into the water base with the assistance of an emulsifier. Additional flavorings are added in concentrations needed to effectively change the taste. Once sprayed on the surface of the chewing tobacco, the solution penetrates into all the tobacco during a soaking period. The water and oil offers immediate moisture to the tobacco and provides long term freshness.

1. This solution adds moisture to chewing tobacco (dip)

2. contains water and oil moisturizing agents along with an emulsifier to keep the oil mixed into the water base. Optional ingredient combinations may or may not contain oil agents as moisturizers.

3. Flavorings are added to change the taste of the tobacco or enhance the existing flavor.

4. Adds longevity and shelf life to the chewing tobacco by keeping tobacco moist for longer period of time

5. Re-moisturizes dry chewing tobacco

6. This solution is not confined to one specific water/oil ratio. It can have a wide variety of water and oil solutions that work toward the purpose of adding moisture to chewing tobacco.
